(19) United States
(12) Patent Application Publication
(10) Pub. No.: US 2007/0023079 A1
(43) Pub. Date: Feb. 1, 2007

(54) Beam splitter

(76) Inventors: David Mills, Roseville (AU); Philipp Schramek, Starnberg (DE); Stephen G. Bosi, Sydney (AU); Anne Gerd Imenes, Sydney (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/454,634

(22) Filed: Jun. 16, 2006

Related U.S. Application Data
(63) Continuation of application No. PCT/AU04/01780, filed on Dec. 17, 2004.

(30) Foreign Application Priority Data
Dec. 18, 2003 (AU) 2003 907028
Feb. 20, 2004 (AU) 2004 900865
May 11, 2004 (AU) 2004 902499
Jun. 4, 2004 (AU) 2004 903018

(51) Int. Cl. H02N 6/00

(52) U.S. Cl. 136/246

(57) ABSTRACT

The present invention provides a beam splitter that comprising a body having at least one substantially flat surface. The surface has surface regions arranged to receive radiation at respective incidence angle ranges. At least some of the incidence angle ranges of the radiation received by the respective surface regions differ from one another and each surface region has a respective optical property such that the influence of the respective incident angle range on the wavelength range of reflected and/or transmitted radiation is reduced.

This application claims priority to: International Application No. PCT/AU2004/001780, with an international filing date of Dec. 17, 2004, which claims priority from: Australian patent application No. 2003 907028, filed Dec. 18, 2003; Australian patent application No. 2004 900865 filed Feb. 20, 2004; Australian patent application No. 2004 902499 filed May 11, 2004; and Australian patent application No. 2004 903018 filed Jun. 4, 2004.

### FIELD OF THE INVENTION

The present invention broadly relates to a beam splitter for splitting radiation into spectral components. The invention relates particularly, though not exclusively, to a beam splitter that may be used for a solar energy reflector array to split collected solar radiation into spectral components.

### BACKGROUND OF THE INVENTION

In many countries the demand for generation of electricity from renewable resources is increasing. The generation of electricity from solar radiation, for example, converting the solar radiation into electricity using photovoltaic cells, has been considered to be relatively inefficient and the cost of energy generated by photovoltaic cells has been relatively high. However, recently significant advances have been made in the area of solar energy reflector arrays that concentrate sunlight to solar towers. As the solar light is concentrated, the area of the photovoltaic cells required for a given amount of power production can be reduced, which makes the generation of electricity from the solar light much more attractive and economical.

Photovoltaic cells utilise p-n junctions in which photons are absorbed and electron-hole pairs are generated. Such p-n junctions require a minimum threshold energy for the generation of the electron-hole pairs and therefore for the generation of electricity. Therefore, solar light having a long wavelength with an energy below the threshold, such as thermal radiation, cannot be converted into electricity by the photovoltaic cells. In particular, the low energy radiation heats the photovoltaic cells and causes a drop in the photovoltaic conversion efficiency, and the removal of the heat requires cooling devices. For the photons above the bandgap energy, the energy in excess of the bandgap energy can not be utilized by the photovoltaic cell and is also dissipated as heat. In order to separate the radiation that can be used to generate electricity by photovoltaic cells from the lower energy radiation, beam splitters may be used that are positioned at the solar towers and are arranged to split the concentrated solar light into the two spectral components. For example, such a beam splitter may have a disc-like configuration centred around the solar tower and photovoltaic cells may be positioned above the beam splitter. Further, the tower may comprise absorbers for thermal radiation that may be positioned below the beam splitter so that the parts of the solar spectrum not suitable for photovoltaic conversion (i.e., the long-wave radiation and parts of the shorter wavelength radiation) can be utilised. The beam splitter then splits the concentrated radiation into the two spectral components.

For example, such a beam splitter may comprise a multi-layered dielectric filter that is arranged to effect splitting of the beam into the two components by interference. However, the interference conditions and therefore the operation of such beam splitters are dependent on the angle of incidence at which the solar beam is received at the beam splitter surface. As solar energy reflector arrays often cover large ground areas, the solar radiation is received at the beam splitter not at one particular angle of incidence but at a range of incidence angles. One way to overcome this problem is to give the beam splitter a complicated surface shape selected so that solar light from different reflectors is received at substantially the same angle of incidence at respective surface portions of the beam splitter. However, beam splitters having such surface shapes are difficult to fabricate.

### SUMMARY OF THE INVENTION

The present invention provides in a first aspect a beam splitter comprising:

a body having at least one substantially flat surface, the surface having surface regions arranged to receive radiation at respective incidence angle ranges,

wherein at least some of the incidence angle ranges of the radiation received by the respective surface regions differ from one another and each surface region has at least one respective optical property such that the influence of the respective incident angle range on the wavelength range of reflected and/or transmitted radiation is reduced.

The or each respective optical property of each surface region typically is selected so that the influence of the incidence range on the wavelength range of radiation that is transmitted and/or reflected by each region is largely compensated.

Throughout this specification the term “surface region” is intended to cover regions located at the surface and regions adjacent to the surface (ie. within a bulk of the body) that perform a beam splitting function. Further, the term “dielectric” is used to describe any material that has at least some dielectric properties also including materials that absorb a portion of the radiation that is transmitted through the material.

The radiation incident on the surface of the body may include a first radiation component having one or more wavelengths in a first wavelength range and a second component having one or more wavelengths in a second wavelength range. Typically at least the majority of the first component is reflected and at least the majority of the second component is transmitted.

As each surface region has at least one respective optical property such that the influence of the respective incident angle range on the wavelength range of reflected radiation is reduced, complicated surface shapes designed to correct for the influence of the incident angle ranges on the reflection properties can be avoided.

For example, the beam splitter may split incident radiation into a number of wavelength ranges, by selectively reflecting and/or transmitting particular wavelength ranges.

In a specific embodiment the beam splitter is arranged to be positioned on a solar tower to receive solar radiation from a solar radiation reflector array.

The body of the beam splitter typically is arranged so that at least the majority of the second radiation component is transmitted by the body. For example, the beam splitter may be arranged so that, when positioned on the solar tower, radiation is directed to a quantum receiver such as a photovoltaic absorber, a thermal absorber, a chemical absorber or any other absorber that has an efficiency that is spectrally dependent.

In one embodiment at least the majority of the second radiation component is transmitted towards a first absorber and at least the majority of the first component is reflected to a second absorber. Each of the first and the second absorbers may be a any type of suitable quantum receiver or photovoltaic absorber. For example, the first and/or second absorber may be a chemical or thermal absorber. In a specific embodiment the first absorber is a photovoltaic absorber and the second absorber is a thermal or chemical absorber. The surface regions typically are arranged to receive radiation from respective concentrators and to direct the received radiation to respective regions of a collector or a light-guide.

The photovoltaic absorber may be positioned above the beam splitter and the thermal or chemical absorber may be positioned below the beam splitter. However, it will be appreciated that this embodiment of the invention is not limited to this particular arrangement. For example, one or more photovoltaic absorbers may be positioned below the beam splitter and one or more thermal and/or chemical absorbers may be positioned above the beam splitter. Further, photovoltaic absorbers may be positioned above and below the beam splitter. In this case the or each photovoltaic absorber that is positioned below the beam splitter typically absorbs radiation in a wavelength range that is different to that of the or each photovoltaic absorber that is positioned above the beam splitter.

In one specific embodiment the beam splitter comprises surface regions that are arranged to receive radiation from respective concentrators, or respective regions of concentrators, which may be part of a solar radiation reflector array. For example, the concentrators may be spheric or parabolic reflectors, Fresnel lenses, compact linear Fresnel reflectors (CLFR) or any other type of lens.

The beam splitter and concentrators that direct light to the beam splitter typically are arranged so that portions of the second radiation component are received at respective surface regions of the beam splitter in a manner such that respective concentrators or concentrator regions are correlated with respective surface regions.

The surface may comprise a multi-layered dielectric structure arranged to influence transmission and/or reflection of received radiation. At each interface of the multi-layered structure a portion of the radiation may be reflected and radiation may interfere. Each surface region may be associated with a portion or segment of the dielectric structure and typically effects respective interference conditions which for reflection of at least a portion of the radiation received at the respective incidence angle range. The multi-layered dielectric structure typically is arranged to transmit at least the majority of the second radiation component and to reflect at least the majority of the first radiation component. In this embodiment the multi-layer dielectric structure has in each surface region layer thicknesses and/or refractive indices selected to reduce the influence of the incident angle range on the wavelength range of the reflected and/or transmitted radiation.

For example, the surface of the beam splitter may have a centre. First surface regions may be closer to the centre than second surface regions. The beam splitter may be arranged to receive light from light reflectors that are close to a solar tower at the first surface regions and light from light reflectors that are further away from the solar tower at the second surface regions. In this case the mean incident angle of the radiation received at the second surface regions is larger (relative to the surface normal) than for the radiation received at the first surface regions. In this embodiment, the layers of the multi-layer dielectric structure have thicknesses that are larger in the second surface regions than in the first surface regions so as to compensate for the effect of the different incident angle ranges on the interference conditions.

In a specific example the layers of the multi-layered dielectric structure may have the layer thicknesses tapered to largely compensate for effects of the different incident angle ranges on the interference conditions. For example, the angle of incidence of the radiation may vary as a function of radial position on the beam splitter and the dielectric structure may have the layer thicknesses tapered radially. Alternatively or additionally the layers of the multi-layered dielectric structure may have a tapered refractive index profile, selected to compensate for effects of the different incident angle ranges on the interference conditions.

In a specific embodiment the beam splitter comprises a multi-layered dielectric structure having tapered layered thicknesses and being arranged for reflection of more than 90%, typically substantially 100%, of radiation in a first wavelength range. In this case the beam splitter typically is arranged to transmit and/or reflect radiation having a wide range of incidence angles on the surface, such as 0-60 degrees.

In another specific embodiment the beam splitter comprises a multi-layered dielectric structure having tapered layered thicknesses and being arranged for transmission of more than 90%, typically substantially 100%, of radiation in the second wavelength range. For example, the beam splitter may comprise an anti-reflection coating, such as an antireflective coating for a photovoltaic absorber.

It will be appreciated, however, that in variations of this embodiment the beam splitter may not necessarily have a centre and may have any other suitable geometric shape. It will also be appreciated that beam splitter may have layer thicknesses or refractive index profile which vary in any suitable manner as required by an application.

The first and second surface regions may be spaced apart and/or may be disposed at different heights relative to a ground plane. Further, the first and second surface portions may have any order relative to each other. For example, light concentrators may be adjusted to direct light to any surface region in which case the surface regions may not be ordered by the incident angle range.

In a variation of this embodiment the multi-layered dielectric structure may be formed so that the transition between the successive layers is substantially continuous and a rugate filter is formed. This absorber has the particular advantage that it may be possible to generate a beam splitter that has negligible secondary lobes (“side-bands”) outside the reflection and/or transmission wavelength range. The composition of the rugate filter is then adjusted according to position on the beam splitter surface to compensate for the effects of the different incidence angle ranges onto the beam splitter.

Each of the surface regions may comprise an individual multi-layered dielectric structure arranged to reflect and/or transmit radiation received at the respective incident angle range. For example the beam splitter surface regions may be attached to respective photovoltaic cells which has the advantage that each dielectric multi-layered structure can be relatively small and therefore is relatively easy to fabricate. Further, this variation has improved flexibility. For example, different materials may be used for different surface regions. Any inactive surface regions of the photovoltaic receiver, e.g., in between individual cells, may be covered with a highly reflective coating to redirect unused light into the thermal receiver and to prevent or reduce overheating of the photovoltaic cells.

The beam splitter may also comprise a holographic structure that is arranged to influence the reflection and/or transmission of received radiation by diffraction and interference and wherein each surface region effects interference conditions which redirect and/or reflect and/or transmit the radiation received at the respective incidence angle range. A holographic structure functions as a diffraction grating and therefore is capable of directing light of a particular wavelength received at a particular angle of incidence. The beam splitter may comprise several holographic structures, superimposed or arranged in different layers, each arranged to redirect and/or reflect and/or transmit radiation received at a respective incident angle range and/or wavelength range.

In a specific example the beam splitter comprises concentric surface regions having holographic structures each arranged to reflect the radiation received at the respective incident angle range. A holographic structure can be generated using suitable software and the generated structures can be transferred onto a carrier material using photographical or lithographical techniques and etching.

In a variation of this embodiment the beam splitter comprises a holographic structure arranged so that the received radiation is split into more than one wavelength range. This particular embodiment has the advantage that the wavelength ranges can be selected to better suit the optimum operation wavelength range of several absorbers and/or photovoltaic cells which increases the efficiency of conversion of radiation energy into electrical energy.

Further, the holographic structure may be arranged so that radiation of different wavelength ranges are projected to respective positions which are located remotely from and/or below the solar tower so that the solar tower may only have to carry the beam splitter and therefore can be a relatively light and inexpensive structure.

The body of the beam splitter may also comprise a multi-layered dielectric structure arranged to influence transmission and/or reflection of received radiation by interference and wherein each surface region effects respective interference conditions for reflection of at least a portion of the radiation received at the respective incidence angle range.

The present invention provides in a second aspect a method of fabricating a beam splitter, the beam splitter having surface regions for receiving radiation at respective incidence angle ranges, at least some of the incident angle ranges differing from one another and each surface region being arranged to reflect at least some of the radiation, the method comprising the step of

imparting at least one respective optical property to each of the surface region such that the influence of incident angle range on the wavelength range of reflected radiation is reduced.

The present invention provides in a third aspect a beam splitter fabricated by the above-defined method.

The present invention provides in a fourth aspect a beam splitter comprising:

a body having surface regions arranged to receive radiation at respective incidence angle ranges and to reflect at least some of the radiation,

wherein at least some of the incidence angle ranges of the radiation received by the respective surface regiones differ from one another and each surface region has at least one respective optical property such that the influence of the respective incident angle range on the wavelength range of reflected radiation is reduced.

For example, the radiation may include a first radiation component having one or more wavelengths in a first wavelength range and a second component having one or more wavelengths in a second wavelength range. Typically, radiation components having a wavelength outside the first wavelength range are not reflected but transmitted.

For example, the beam splitter may be arranged to split the first radiation component from the radiation received from respective surface regions of a radiation reflector and direct the first radiation component to respective surface regions of the collector. The body may comprise at least one optically guiding medium, such as an optical fibre, that is arranged to guide the first radiation component and irradiate radiation having a wavelength outside the first wavelength range through walls of the guiding medium. In a specific embodiment, the first radiation component is guided to a photovoltaic cell and radiation transmitted through walls of the guiding medium is received by a thermal or a chemical absorber.

The invention will be more fully understood from the following description of specific embodiments of the invention. The description is provided with reference to the accompanying drawings.

### BRIEF DESCRIPTION OF THE DRAWINGS

FIG. 1 shows a schematic representation of a solar radiation collection system according to a specific embodiment,

FIGS. 2 (a)-(d) show two-dimensional plots for calculated flux distributions,

FIG. 3 shows one-dimensional plots for calculated energy within a circular receiver according to an embodiment of the invention,

FIG. 4 shows plots for the angular distribution of the radiation for a cross-section through three receiver surfaces,

FIG. 5 shows a schematic cross-sectional representation of a beam splitter according to another specific embodiment,

FIG. 6 shows calculated reflectance profiles for a beam splitter filter according to an embodiment of the invention (a) with and (b) without suitable adjustments of the thin film thickness profile according to the angle of incidence as a function of position on the beam splitter filter,

FIG. 7 shows a schematic view of a beam splitter according to a further specific embodiment and

FIG. 8 shows a schematic cross-sectional representation of a beam splitter according to another specific embodiment.

### DETAILED DESCRIPTION OF SPECIFIC EMBODIMENTS

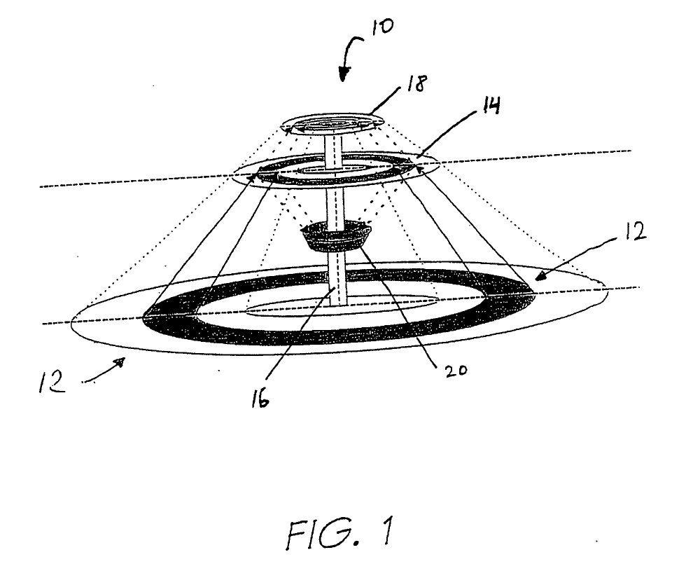

Referring initially to FIG. 1, a solar radiation collection system according to a specific embodiment is now described. The system 10 comprises a field of heliostats 12 arranged to receive sunlight and to reflect the sunlight to beam splitter 14. The beam splitter 14 is positioned on a solar tower 16. In this embodiment the heliostats are ranged so that each heliostat reflects and concentrates the sunlight to a respective surface area of the beam splitter 14 so that respective areas of the beam splitter 14 are associated with respective reflectors. The beam splitter 14 is arranged to split the received radiation into a first radiation component having a wavelength in a first spectral range and a second radiation component having a wavelength outside the first wavelength range. The second radiation component is transmitted while a portion of the first radiation component is reflected by the beam splitter 14. The second radiation component is directed to photovoltaic absorber 18 which is in this embodiment positioned above the beam splitter 14 and the first radiation component is directed to a thermal absorber 20 which in this embodiment is positioned below the beam splitter 14.

In order to generate electron-hole pairs in the photovoltaic absorber 18 and therefore to generate electricity, the absorbed photons have to have a minimum threshold energy. In an edge filter design, the beam splitter 14 is arranged so that the photons transmitted to the photovoltaic absorber 18 have largely an energy above the threshold and most of the photons having an energy below the threshold are directed to the thermal absorber 20. Alternatively, a bandpass design may be used that also allows the high energy photons that cannot be fully utilized by the photovoltaic receiver, and may also degrade the photovoltaic receiver, to be directed to the thermal absorber. Both these arrangements have the advantage that heating of the photovoltaic absorber 18 can be minimised and low energy radiation, such as thermal radiation, can be used to generate electricity using thermal absorber 20.

The beam splitter 14 may also be designed to function as a band stop filter, or alternatively as a spectrally selective filter that reflects and/or transmits multiple spectral bands simultaneously.

The following will describe the design of a beam splitter such as beam splitter 14 in more detail.

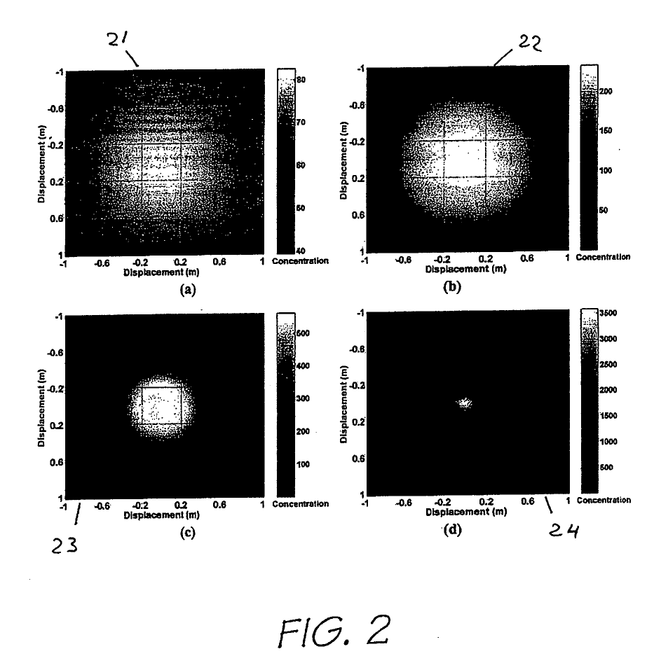

FIG. 2 shows the flux distribution in the focal region of a single-tower central receiver system such as that schematically indicated in FIG. 1 and described above. The flux distribution was calculated for Sydney, Australia, at 1:06 pm on 1 Jan. 2000. For this calculation the system 10 is assumed to comprise a circular field of closely packed, circular heliostats of paraboloidal cross-section, with a common aiming point on top of a 10 m high tower. The flux distribution was calculated using parameters summarised in Table 1.

For the calculation of the flux distribution a ray-trace program was used which is described in Buie D. and Imenes A. G. (2003), “A solar and vector class for the optical simulation of solar concentrating systems”, In Proc. ISES Solar World Congress, June 14-19, Gothenburg, Sweden, P6 76.

The terrestrial solar beam is defined by means of the position of the sun in the sky, its spectral and spatial energy distribution, and the broadening of the spatial energy distribution after its reflection off a non-ideal mirrored surface. An important parameter is the circumsolar ratio (CSR), which is defined as the radiant flux contained within the circumsolar region of the sky, divided by the radiant flux from the direct beam and aureole. The spatial energy distribution of the sun, if represented by its CSR, will on average be invariant to change in geographic location. A standard sun shape distribution has been chosen here, with a typical value for the CSR of 5%. Of equal importance is the optical characteristics of the reflecting modules. Here it is assumed that the mirrors of the heliostats have a standard deviation of surface errors of 3.5 mrad and an ideal tracking regime.

FIG. 2 shows the calculated flux distributions 21, 22, 23 and 24 as a function of displacement from the centre of the receiver, for a 2×2 m² receiver surface that is placed at a distance of (a) 1.0 m, (b) 0.6 m, (c) 0.4 m and (d) 0.2 m below the focal plane of the heliostat field.

TABLE 1

| Solar disc limit | 4.65 mrad |
|---|---|
| Circumsolar limit | 43.6 mrad |
| CSR | 5% |
| Mirror error std. deviation | 3.5 mrad |
| Longitude, latitude | (151.2, −33.9) deg |
| Time-zone | +11 hrs |
| Day, month, year | 1, 1, 2000 |
| Hour, minute, second | 13, 6, 0 |
| Solar azimuth, zenith | (350.6, 10.9) deg |
| Tower height | 10 m |
| Mirror diameter | 1 m |
| Number of heliostats | 716 |

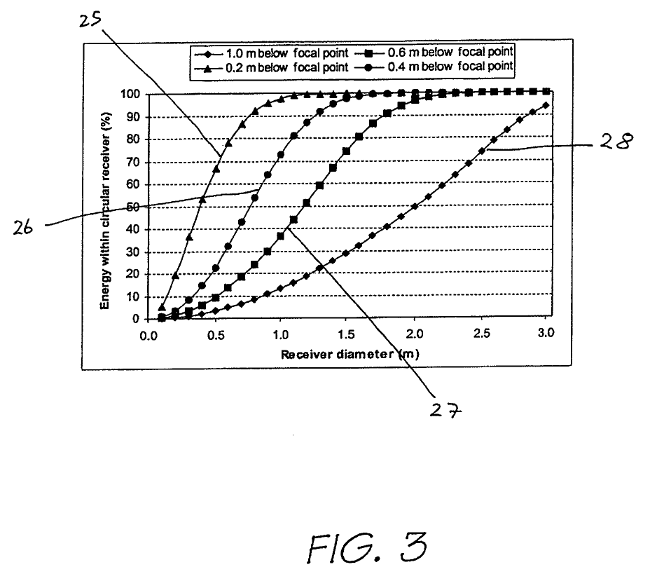

The calculated energy intercepted by a circular receiver placed in a horizontal plane 0.2 m (25), 0.4 m (26), 0.6 m (27), and 1.0 m (28) below the focal point is shown in FIG. 3. A circular receiver of diameter 1.5 m placed 0.4 m below the focal point would collect about 97% of the energy intercepted and reflected by the mirror field. The corresponding peak concentration would in this case be 550 suns.

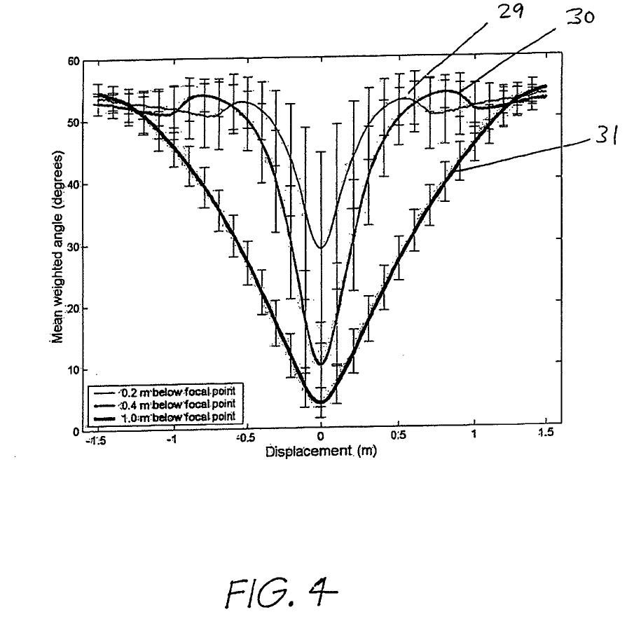

Next, the angular energy distribution of the radiation incident on a beam splitter 14 in the focal region of the system 10 illustrated in FIG. 1 should be considered. As there will be some overlap of rays due to the sun shape and mirror surface errors, it is necessary to determine the distribution of the mean angle and the standard deviations for the energy intercepted by a flat receiver in the focal region. Plots 29, 30 and 31 of FIG. 4 show the angular distribution of radiation for a cross-section through the centre of a receiver placed 0.2 m. 0.4 m, and 1.0 m below the focal point. The mean weighted angle μ and its standard deviation σ are defined as follows:

$$\begin{matrix}μ = \frac{{{\sum }_{i}}^{n} {θ}_{i} {ω}_{i}}{{\sum }_{i}^{n} {ω}_{i}} & eq . ( 1 ) \\ σ = \sqrt{\frac{{\sum }_{i}^{n} {( {θ}_{i} - μ )}^{2} {ω}_{i}}{{\sum }_{i}^{n} {ω}_{i}}} & eq . ( 2 )\end{matrix}$$

In eq. (1) and (2), ωᵢ refers to the energy of ray i, which incident at an angle θᵢ. For a given position on the receiver, the mean weighted angle is thus found by summing the product of the angle and the energy of ray i over all rays n, and dividing by the total energy of all rays n. The standard deviation is the square root of the variance of the mean.

From FIG. 4 it can be seen that for a beam splitter placed 0.4 m below focus, the mean weighted angle follows a curve ranging from about 10 to about 54 degrees, with a standard deviation of about 8 degrees for the smaller angles and about 3 degrees for the large angles of incidence. These deviations are within acceptable limits for a satisfactory beam splitter performance. The standard deviations are larger for a receiver position closer to the focal plane than for receiver positions further away from the focal plane. The larger standard deviations closer to the focal plane are caused by a larger overlap of rays originating from different directions of the heliostat field. The distribution of the mean weighted angle is in this case heavily influenced by the substantial amount of energy originating from the outer regions of the heliostat field.

As the receiver is moved further down below the focal plane, there is less overlap of rays from different parts of the heliostat field and the standard deviations decrease. At any given point on the absorber, most of the energy is now originating from a rather narrow angular cone. In this case, the distribution of the mean weighted angle shows a larger variation across the absorber plane: The central region of the absorber receives most of its energy from the heliostats in the close proximity of the tower and hence the mean weighted angle will attain a small value. The outer regions of the absorber receive energy from heliostats located further away, and the mean weighted angle increases correspondingly.

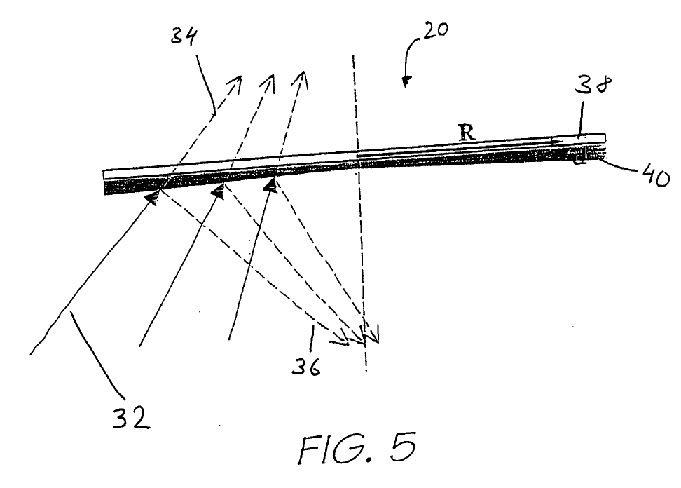

FIG. 5 shows a beam splitter 20 according to another specific embodiment. In this case the beam splitter 20 is arranged to split radiation 32 received from a solar reflector array (not shown) and transmit a second radiation component 34 to a photovoltaic absorber (not shown) and direct the remaining radiation 36 to a thermal absorber (not shown). The beam splitter 20 comprises a transparent and disk like optically transmissive substrate 38 upon which a multi-layered tapered dielectric structure 40 is deposited. An alternative arrangement includes a disk-like optically transmissive substrate 38 upon which a multi-layered tapered dielectric structure 40 is deposited on the front side, and an additional multi-layered tapered dielectric structure is deposited on the back side for improved optical performance (not shown).

The dielectric structure 40 is shaped to account for changes in the optical admittance of a thin film which occurs as the angle of incidence is increased and which influences the optical pathlength, as seen by a propagating ray of light, and hence the interference characteristics of the film (for clarity FIG. 5 shows the dielectric structure having a greatly exaggerated thickness difference between inner and outer areas). For a given thin film thickness, d, the optical pathlength is changed in such a way that the incident wave in effect sees a thinner layer as the angle is increased. To compensate for this change in pathlength, the thickness of the thin film should at a non-normal angle of incidence θ be increased relative to the film thickness d at normal incidence, in accordance with equation 3.

$${d}_{c} = {d ( 1 - {( \frac{{n}_{1}}{{n}_{2}} )}^{2} {sin}^{2} θ )}^{- 0.5} \qquad ( 3 )$$

In eq. (3), n₁ is the refractive index of the incident medium or incident layer, and n₂ is the refractive index of the thin film layer to be adjusted.

Suitable dielectric materials for the deposition and manufacture of the multi-layer filter include, but are not restricted to, materials of a higher refractive index such as Si₃N₄, Y₂O₃, Ta₂O₅, ZnS, or TiO₂ with refractive indices in a range of approximately 1.8-2.4, and materials of a lower refractive index such as MgF₂, LiF, CaF₂, SiO₂, or Al₂O₃ with refractive indices in a range of approximately 1.4-1.7.

An example of a typical bandpass window for the multi-layered structure may be given for a photovoltaic receiver consisting of mono-crystalline silicon cells with a photon threshold value at 1.1 eV, corresponding to an incident photon of wavelength 1.1 micrometer. The transmissive region of the bandpass filter would then have an upper edge close to 1.1 micrometer, whereby all radiation with wavelength longer than 1.1 micrometer would be reflected to the thermal receiver. The lower edge would normally be determined from the optimisation of the electric conversion efficiency of the combined receivers, e.g., by comparing the (spectral) efficiency of the thermal receiver with the spectral efficiency of the photovoltaic receiver, and in a typical configuration may be chosen somewhere between 0.5-0.7 micrometer, for instance at 0.6 micrometer. All photons with wavelength shorter than 0.6 micrometer would be reflected to the thermal receiver. The bandpass filter would in this example transmit at least the majority of the radiation of wavelength between 0.6 micrometer and 1.1 micrometer to the photovoltaic receiver. A different choice of photovoltaic and thermal receivers may result in an different optimum bandpass region.

The multi-layered structure 40 comprises a large number of layers each having an optical thickness that approximates one or more quarterwaves in optical thickness, relative to a reference wavelength λ, but may typically involve layer thicknesses ranging from a few nanometers to a few hundred nanometers as a result of optimisation calculations performed to satisfy a complex edge filter or band pass design. At each interface of the multi-layered structure a portion of the radiation is reflected and transmission of multi-layered structure is maximised if the radiation reflected at the respective interfaces interfere destructively with each other. The layer thicknesses are chosen so that an edge filter or band-pass transmission filter profile is achieved. Therefore, for a predetermined wavelength range corresponding to the edge filter or band pass, the beam splitter transmits radiation to the photovoltaic cell whereas at other wavelengths ranges the transmission of the sunlight to the photovoltaic cell is reduced.

The effective optical path lengths of the light in each layer depends on the angle of incidence. In this embodiment the solar radiation collection system 10 is arranged so that surface regions that are closer to the centre of the beam splitter receive radiation from heliostats that are closer to the solar tower 16 and surface areas that are further away from the centre receive the radiation from heliostats that are further away from the solar tower 16. In order to ensure that the radiation, irrespective of the angle of incidence, experiences the same spectral splitting properties by the beam splitter 20, the thicknesses of the layers 40 increase from the inner surface region of the beam splitter 20 to the outer surface region.

The multi-layered dielectric structure 40 may be deposited using a method and apparatus as disclosed in the co-pending Australian provisional patent application entitled “Apparatus for Plasma Treatment” filed on 20 Feb. 2004. This provisional patent application discloses an apparatus having a hollow cathode which scans relative to a substrate in a predetermined manner to coat the substrate in a predetermined manner.

In a variation of this embodiment the multi-layered dielectric structure 40 may be arranged to have continuous transitions between adjacent layers and a rugate filter is formed. Such a rugate filter has the advantage that secondary transmission or reflection lobes outside the desired wavelength range of maximum transmission or reflection can be reduced, and may also reduce manufacture and durability problems related to stress, cracking and adhesion due to the continuous nature of the structure.

The following will describe further design criteria for the fabrication of a beamsplitter such as beamsplitter 20 shown in FIG. 5. The optimisation of a multi-layered structure, such as the multi-layered structure 40, is in this embodiment based on calculations of a so-called “merit function”, which is a numerical measure of the correspondence between the actual and the desired spectral characteristics of the design. The smaller the merit function, the closer the correspondence between target and actual design characteristics. The example used here has a target function defined by the optimum electrical output from a high-concentration mono-crystalline silicon PV receiver and a heat engine operating in parallel. The ideal (“target”) spectral pass-band profile takes the shape of a simple square profile. The tolerance of the target function has been defined by means of the product of the incident air mass 1.5 (i.e., solar incidence angle 48 degrees) direct solar spectrum and the spectral efficiencies of the receivers at the design point, which creates a weighting procedure for the merit function.

When defining the filter target function, the spectral bandwidth over which the filter will be effective should be carefully considered, as a narrower bandwidth will improve the resulting layered structure produced by the numerical optimisation procedure. The normalised spectral distribution of accumulated integral direct normal irradiation shows very little variation over the range of incidence angles experienced during the major part of the day, i.e., from air mass 1 to 3 (solar incidence angles ranging from 0 to 70 degrees). Only slightly more than 1% of the sunlight is incident in the IR region beyond 2500 nm, hence this wavelength may be set as a convenient upper boundary for the spectral target function. Similarly, only about 1% of the sunlight is incident below 350 nm, which may be chosen as the lower boundary for the target function. However, as exposure to UV light could cause damage to the PV cells, the beam splitter may be designed to reflect the harmful light away from the cells. In this case, the lower limit for the target function may be moved down to ˜300 nm, which is the approach chosen here.

In this embodiment a “needle” numerical optimisation technique has been used to calculate a thin film refractive index profile for the coating 40 that results in a bandpass filter-function. For further information about the needle technique reference is made to Tikhonravov A. V., Trubetskov M. K. and DeBell G. W. (1997), “Design of coatings for wide angular range applications”, In Optical Thin Films V: New Developments, Proc. SPIE 3133, 30 July-1 August, San Diego, Calif., pp. 16-24.

The TFCalc thin film software was used to optimise the filter for a cone of incident solar radiation, assumed to have a mean angle of incidence μ and standard deviation σ; and incident at the maximum mean weighted angle of 54 degrees, in accordance with plot 30 in FIG. 4. For the TFCalc software reference is being made to TFCalc thin film design software, Software Spectra, Inc., Portland.

The needle optimisation was started with a single 10 μm thick layer of the high index material TiO₂ (n_{H}=2.3 at 1000 nm) on the front surface of the substrate, and a 1 μm thick TiO₂ layer on the back surface. The low index material was SiO2 (n_{L}=1.43 at 1000 nm) and the substrate was 3 mm thick glass (n_{S}=1.51 at 1000 nm), with air as the surrounding medium. The materials were assumed to dispersive and absorption-free.

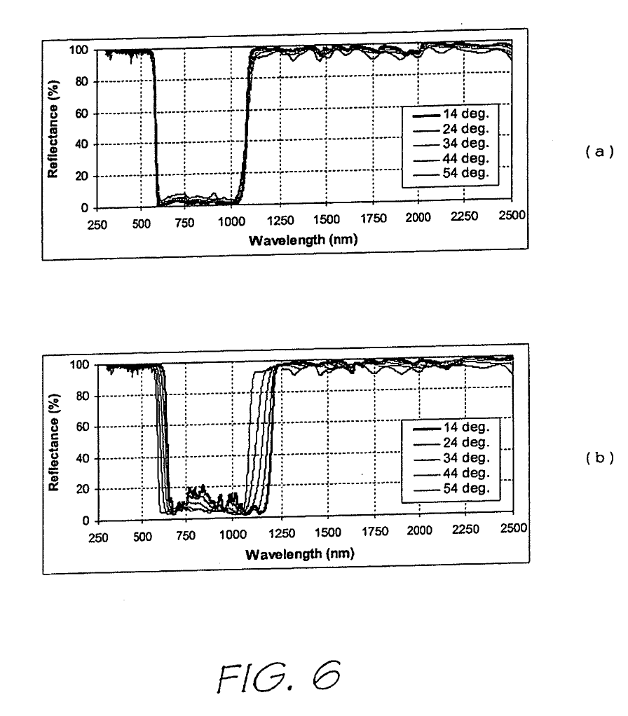

The optimisation was performed at the largest predicted value for the mean weighted angle. As will be shown in FIG. 6, the resulting optimised design has an improved performance at smaller values of the mean weighted angle when the film thicknesses are adjusted according to eq. (3). The reflectance profile of the resulting design is shown in FIG. 6 (a), for a cone of light incident at mean weighted angles ranging from 14 to 54 degrees, in steps of 10 degrees. The individual layer thicknesses were all adjusted as the incidence angle was changed, according to eq. (3). The overall filter performance can be seen to improve as the angle of incidence is reduced from the design angle of 54 degrees. In this embodiment the resulting design has 162 layers (149 at the front, 13 at the back), with a total thickness of ˜13 μm in the centre and ˜15 μm at the rim of the filter. FIG. 6 (b) shows corresponding results for which the layer thicknesses were not adjusted according to eq. (3).

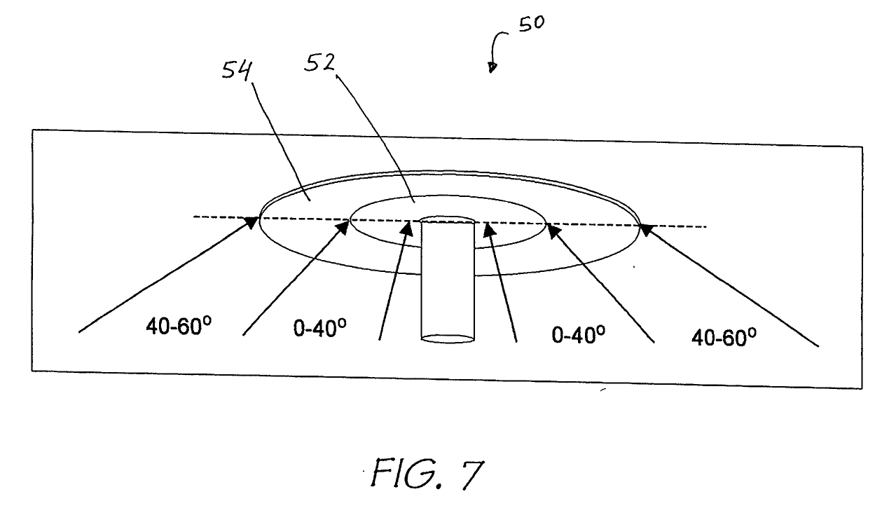

FIG. 7 shows a beam splitter 50 which comprises a first surface region 52 and a second surface region 54. Each surface region has a multi-layer dielectric structure of the type as discussed in the context of the beam splitter 20 shown in FIG. 5 but which in this embodiment does not comprise layers having a radially tapered thickness to account for the different incident angle ranges. In this embodiment the layer thicknesses in the first surface region 52 are chosen so that they are suitable for incident angle ranges of 0°-40° (relative to the surface normal) and the second surface region 54 has slightly thicker layers which are suitable for incident angle ranges of 40°-60° It should be appreciated that the invention is not limited to two surface regions only, and is not limited to the incident angle ranges given by this example.

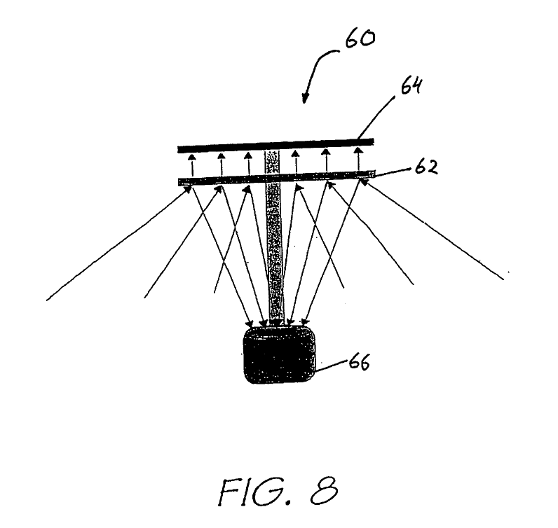

FIG. 8 shows another embodiment 60 of the system, in which the beam splitter comprises a holographic structure 62, such as a volume hologram, that is arranged to direct radiation of the first wavelength range to a first area that in this embodiment coincides with the surface of a photovoltaic absorber 64. In this embodiment, the majority of the radiation having a wavelength outside the second wavelength range is directed to thermal absorber 66.

The holographic structure functions similar to a diffraction grating and therefore can direct radiation of a particular wavelength range received at a particular angle of incidence. For example, the holographic structure may be formed into a photosensitive material using known laser interference or etching techniques.

Typically a number of holograms are superimposed, each recorded at a slightly different wavelength so that overall response of the hologram will approximate that of a band pass filter. In this embodiment, the holographic structures are recorded taking into account the angle of incidence at which the radiation is received, which increases (relative to the surface normal) from an inner surface region of the beam splitter to an outer surface region.

The fabrication of a solar hologram may be accomplished by splitting a laser source into two coherent beams. Using an optical system consisting of lenses and mirrors, one of the beams is collimated to impinge as parallel rays onto the recording plate. The other beam diverges as a spherical wave onto the recording plate at a given angle of incidence, which must be determined by the desired characteristics of the resulting holographic filter. Both beams have approximately the same intensity at the recording plate. The angle and the hologram thickness are chosen so that a given portion of the solar spectrum is efficiently diffracted. By stacking several holograms on top of each other, the diffracted portion of the solar spectrum may be extended. For a fixed direction of the illuminating wave, each hologram diffracts a different part of the incident wavelength spectrum into the same direction, thereby creating either a transmission band or a reflection band. The order in which the holograms are arranged may be important to avoid coupling between the different holograms, which will decrease diffraction efficiency.

One method of fabricating holographic optical filters is to place one or more layers of photosensitive dichromated gelatin on a glass or plastic film substrate. The holographic films may be embedded between glass plates to provide for rigidity, strength and protection against moisture. For example, an Argon laser with a wavelength of 488 nm may be used to record a diffraction pattern in a dicrhomated gelatin layer, typically a few micrometer thick, that will cause filtering of light within the visible region. The incidence angles of the two coherent laser beams are altered for each recording so that the recorded diffraction pattern covers a range of wavelengths. Equivalently, for light of a given wavelength, the incidence angle will determine the path along which the photons will be reflected or transmitted, as set by the recording geometry.

Although the invention has been described with reference to particular examples, it will be appreciated by those skilled in the art that the invention may be embodied in many other forms. For example, the beam splitter may not be arranged for usage in a solar radiation collection system but may be suitable for other applications.

It will also be appreciated by those skilled in the art that the beam splitter may take the form as either an edge filter, a band pass filter, or a band stop filter, and may split the beam into more than two spectral components.

The beam splitter may not have a circular shape, but may take another suitable shape (including non-symmetrical and irregular shapes), such as a rectangular or elliptical shape, according to the geometry of the radiation collection system and the surface regions may have any suitable order.

Further, it will be appreciated by those skilled in the art that the body of the beam splitter may not necessarily be flat, but may comprise substantially flat portions which may have any spatial relation relative to each other. For example, the substantially flat surface portion may be spaced apart and may also be off-set in a direction perpendicular to one of the surface portions.

It will further be appreciated by those skilled in the art that the incident beam may be split into suitable spectral components for other receivers than the mentioned photovoltaic and thermal receivers, for example, a low-bandgap photovoltaic receiver may be used for the low-energy part of the incident solar spectrum and various thermal or chemical receivers may be used for the high-energy part of the incident solar spectrum. For example a chemical receiver may be used that is arranged so that respective chemical reactions may by induced when radiation of respective wavelength ranges is absorbed.

Furthermore, it will be appreciated that the tapering of the layered filter thicknesses and/or the material composition that will account for the different incident angle ranges onto the beam splitter may proceed either in a continuous or discrete fashion. Furthermore, it will be appreciated that the dielectric layered structure may be used either on its own or in combination with the holographic structure in order to perform the desired splitting of the incident solar spectrum.

The beam splitter may be arranged to receive radiation from any type of concentrator including reflectors (for example, spherical or parabolic reflectors), Fresnel lenses or any other type of lens.

1. A beam splitter comprising:
a body having at least one substantially flat surface, the surface having surface regions arranged to receive radiation at respective incidence angle ranges,
wherein at least some of the incidence angle ranges of the radiation received by the respective surface regions differ from one another and each surface region has at least one respective optical property such that the influence of the respective incident angle range on the wavelength range of reflected and/or transmitted radiation is reduced.

2. The beam splitter as claimed in claim 1 wherein the or each respective optical property of each surface region is selected so that the influence of the incidence range on the wavelength range of radiation that is transmitted and/or reflected by each surface region is largely compensated.

3. The beam splitter as claimed in claim 1 wherein the radiation includes a first radiation component having one or more wavelengths in a first wavelength range and a second component having one or more wavelengths in a second wavelength range and wherein at least the majority of the first component is reflected and at least the majority of the second component is transmitted.

4. The beam splitter as claimed in claim 1 being arranged to be positioned on a solar tower to receive solar radiation from a solar radiation reflector array.

5. The beam splitter as claimed in claim 4 being arranged so that, when positioned on the solar tower, at least the majority of the first radiation component is reflected to a first absorber and at least the majority of the second component is transmitted towards a second absorber.

6. The beam splitter as claimed in claim 5 wherein at least one of the first and the second absorber is a thermal absorber.

7. The beam splitter as claimed in claim 5 wherein at least one of the first and the second absorber is a chemical absorber.

8. The beam splitter as claimed in claim 5 wherein at least one of the first and the second is a photovoltaic absorber.

9. The beam splitter as claimed in claim 1 wherein the body is arranged so that at least the majority of the second radiation component is transmitted by the body.

10. The beam splitter as claimed in claim 1 wherein the beam splitter and concentrators that direct light to the beam splitter are arranged so that portions of the second radiation component are received at respective surface regions of the beam splitter in a manner such that respective concentrators or concentrator regions are correlated with respective surface regions.

11. The beam splitter as claimed in claim 10 comprising surface regions that are arranged to receive radiation from respective concentrators and to direct the received radiation to respective regions of a collector or a light-guide.

12. The beam splitter as claimed in claim 11 wherein each concentrator is a reflector of a solar energy reflector array.

13. The beam splitter as claimed in claim 10 wherein the collector is a photovoltaic absorber.

14. The beam splitter as claimed in claim 1 wherein the body comprises a multi-layered dielectric structure arranged to influence transmission and/or reflection of received radiation by interference and wherein each surface region effects respective interference conditions for reflection of at least a portion of the radiation received at the respective incidence angle range.

15. The beam splitter as claimed in claim 14 wherein the multi-layered dielectric structure is arranged to transmit at least the majority of the second radiation component and to reflect at least the majority of the first radiation component.

16. The beam splitter as claimed in claim 14 wherein the multi-layered dielectric structure has in each surface region layer thicknesses selected to reduce the influence of the incident angle range on the wavelength range of the reflected and/or transmitted radiation.

17. The beam splitter as claimed in claim 1 being arranged for positioning on a solar tower of a solar radiation reflector array, the surface having a centre, with first surface regions that are closer to the centre than second surface regions, and wherein the first surface regions are arranged to receive light from reflectors that are closer to the solar tower and the second surface regions are arranged to receive light from reflectors that are further away from the solar tower.

18. The beam splitter as claimed in claim 14 being arranged for positioning on a solar tower of a solar radiation reflector array, the surface having a centre, with first surface regions that are closer to the centre than second surface regions, wherein the first surface regions are arranged to receive light from reflectors that are closer to the solar tower and the second surface regions are arranged to receive light from reflectors that are further away from the solar tower, and wherein the layers of the multi-layered dielectric structure have thicknesses that are larger in the second surface regions than in the first surface regions.

19. The beam splitter as claimed in claim 18 wherein the layers of the multi-layered dielectric structure have a tapered thickness as a function of position on the beam splitter surface.

20. The beam splitter as claimed in claim 16 wherein the layers of the multi-layered dielectric structure have thicknesses that are varied as a function of position on the receiving surface.

21. The beam splitter as claimed in claim 16 wherein the multi-layered dielectric structure has tapered layered thicknesses and is arranged for reflection of more than 90% of the radiation in a first wavelength range.

22. The beam splitter as claimed in claim 16 wherein the multi-layered dielectric structure has tapered layered thicknesses and is arranged for transmission of more than 90% of radiation in the second wavelength range.

23. The beam splitter as claimed in claim 14 wherein the multi-layered dielectric structure is formed so that the transition between successive layers is substantially continuous such that a rugate filter is formed.

24. The beam splitter as claimed in claim 14 wherein each of the surface regions comprises an individual multi-layered dielectric structure arranged to reflect the radiation received at the respective incident angle range.

25. The beam splitter as claimed in claim 24 wherein the surface regions are attached to respective photovoltaic cells.

26. The beam splitter as claimed in claim 1 wherein the body comprises a holographic structure that effects respective diffraction and interference conditions which reflect and/or transmit the radiation received at the respective incidence angle range.

27. The beam splitter as claimed in claim 26 comprising concentric surface regions each having a holographic structure arranged to reflect and/or transmit at least the majority of the radiation received at the respective incident angle range.

28. The beam splitter as claimed in claim 26 wherein the or each holographic structure is arranged so that more than one wavelength ranges are reflected and/or transmitted from the radiation received at the respective incident angle range.

29. The beam splitter as claimed in claim 28 wherein the holographic structure is arranged so that radiation of different wavelength ranges is directed to respective positions.

30. The beam splitter as claimed in claim 26 wherein the body also comprises wherein the body comprises a multi-layered dielectric structure arranged to influence transmission and/or reflection of received radiation by interference and wherein each surface region effects respective interference conditions for reflection of at least a portion of the radiation received at the respective incidence angle range.

31. A method of fabricating a beam splitter, the beam splitter having surface regions for receiving radiation at respective incidence angle ranges, at least some of the incident angle ranges differing from one another and each surface region being arranged to reflect at least some of the radiation, the method comprising the step of
imparting a at least one respective optical property to each of the surface region such that the influence of the respective incident angle range on the wavelength range of reflected and/or transmitted radiation is reduced.

32. A beam splitter fabricated by the method claimed in claim 31.

33. A beam splitter comprising:
a body having surface regions arranged to receive radiation at respective incidence angle ranges
wherein at least some of the incidence angle ranges of the radiation received by the respective surface regiones differ from one another and each surface region has at least one respective optical property such that the influence of the respective incident angle range on the wavelength range of reflected and/or transmitted radiation is reduced.
